(19) United States
(12) Patent Application Publication
(10) Pub. No.: US 2026/0203316 A1
(43) Pub. Date: Jul. 16, 2026

(54) OPTIMIZED CONTENT GENERATION

(71) Applicant: Micro Focus LLC, Wilmington, DE (US)

(72) Inventors: Yaniv Sayers, Holon (IL); Yuval Koren, Rishon (IL); Elimelech Emanuel, Ramat Gan (IL)

(21) Appl. No.: 19/449,914

(22) Filed: Jan. 15, 2026

Related U.S. Application Data
(60) Provisional application No. 63/746,250, filed on Jan. 16, 2025.

(51) Int. Cl. G06F 16/3329; G06F 16/334; G06F 16/901

(52) U.S. Cl. CPC G06F 16/3329; G06F 16/3347; G06F 16/9024

(57) ABSTRACT

The present disclosure is directed to a system and method that provides a unified context graph mapping semantically context providers to corresponding entities and/or attributes, each entity being related to one or more of the attributes, provides a first prompt comprising user selected entities to a language model (LM) to determine, based on the unified context graph and from among the context providers, a first set of relevant context providers, transforms an attribute of the selected entities into an attribute vector embedding semantically describing the attribute, compares the attribute vector embedding with vector embeddings associated with the context providers, to determine a second set of relevant context providers different from the first set of relevant context providers, generates, from the first and second sets of relevant context providers, context associated with the selected entities, and determines from a second prompt comprising the generated context a LM reply to provide to the user in response to the user input.

### CROSS REFERENCE TO RELATED APPLICATION

The present application claims the benefits of U.S. Provisional Application Ser. No. 63/746,250, filed Jan. 16, 2025, entitled “OPTIMIZED CONTENT GENERATION”, which is incorporated herein by this reference in its entirety.

### FIELD

The present disclosure is related generally to crafting prompts to a large language model (LLM) and specifically to crafting prompts using relevant context extracted from information that is not in the form of a structured document.

### BACKGROUND

Natural language processing has witnessed remarkable advancements in recent years due to a proliferation of large language models (LLMs). LLMs can understand context, generate human-like text, and perform various language-related tasks with astonishing accuracy.

There are several patterns to gain superior results from an LLM:

Prompt Engineering crafts specific, well-structured input queries to guide the LLM towards desired outputs. This involves designing prompts that effectively communicate the task and context to the model.

RAG (Retrieval-Augmented Generation) enhances the LLM's responses by retrieving relevant information from an external knowledge base before generating the output. This combines the model's general knowledge with specific, up-to-date information.

Fine-tuning adapts a pre-trained LLM on a smaller, task-specific dataset to improve its performance on particular tasks or domains. This tailors the model's existing knowledge to specific use cases.

Pre-training initially trains an LLM on a large, diverse dataset to build its foundational knowledge and capabilities. This is typically done by the model's creators before release and forms the base for further adaptations.

These patterns have different requirements, tradeoffs and benefits.

Pretraining from scratch and fine tuning require high ongoing computational effort as well as extensive training data sets.

Commonly a RAG implementation is suitable for documents, which means a coherent piece of information that can be independently retrieved and that can augment the generation process, such as an article, a report, an FAQ entry, or a database record. It is generally unsuitable for information that is not structured as documents, particularly information structured through entities and relationships.

While LLMs have vast knowledge, they need guidance to apply that knowledge effectively to specific tasks or questions.

### SUMMARY

These and other needs are addressed by the various aspects, embodiments, and configurations of the present disclosure.

In an aspect of the disclosure, the present disclosure provides a system and method that provide a unified context graph mapping semantically a plurality of context providers to corresponding entities and/or attributes, each entity being related to one or more of the attributes, receive, by a user interface, user input selecting one or more entities, provide a first prompt comprising the selected one or more entities to a language model (LM) to determine, based on the unified context graph and from among the plurality of context providers, a first set of relevant context providers, transform, by an embedding model, an attribute of the selected one or more entities into an attribute vector embedding semantically describing the attribute, compare the attribute vector embedding with vector embeddings associated with the plurality of context providers, to determine a second set of relevant context providers different from the first set of relevant context providers, generate, from the first and second sets of relevant context providers, context associated with the selected one or more entities, and determine from a second prompt comprising the generated context a LM reply to provide to the user in response to the user input.

Additional features and advantages are described herein and will be apparent from the following Description and the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of an application management system in accordance with aspects of the present disclosure;

FIG. 2 is a block diagram illustrating elements of an exemplary Application Lifecycle Management (ALM) according to one embodiment of the present disclosure;

FIG. 3 is a block diagram of an Artificially Intelligent (AI)-based content assistant in accordance with aspects of the present disclosure;

FIG. 4 is a block diagram of a set of data structures in the ALM database in accordance with aspects of the present disclosure;

FIG. 5 is a block diagram of a set of data structures in a unified context graph in accordance with aspects of the present disclosure;

FIG. 6 is a process flow illustrating aspects of the AI-based content assistant in accordance with aspects of the present disclosure;

FIG. 7 is a process flow illustrating aspects of the AI-based content assistant in accordance with aspects of the present disclosure; and

FIG. 8 is a process flow illustrating aspects of the AI-based content assistant in accordance with aspects of the present disclosure.

### DETAILED DESCRIPTION

In the following description, for the purposes of explanation, numerous specific details are set forth to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

The present disclosure is directed to a system that engineers a specialized prompt or an orchestration of a chain of prompts for every knowledge expert bot (e.g., Agile™ planning bot, performance engineering bot, etc.) and for every key use case (e.g., break a feature into user stories, generate a test, etc.) as a reusable prompt template. To enable user requests and policies to match the required expertise, each prompt template can include in natural language a description of what it can fulfill (the use case and problem solved). In addition, the required context, the expected output, and the required type of LLM (for a poly LLM array) can be included.

More specifically, embodiments of the disclosure are directed to a system and method that provide a unified context graph mapping semantically a number of context providers to corresponding entities and/or attributes, each entity being related to one or more of the attributes, receive user input selecting one or more entities, provide a first prompt comprising the selected entities to a language model (LM) to determine, based on the unified context graph and from among the context providers, a first set of relevant context providers, transform, by an embedding model, an attribute of the selected entities into an attribute vector embedding semantically describing the attribute, compare the attribute vector embedding with vector embeddings associated with the context providers to determine a second set of relevant context providers different from the first set of relevant context providers, generate, from the first and second sets of relevant context providers, context associated with the selected entities; and determine from a second prompt comprising the generated context a LM reply to provide to the user in response to the user input. As will be appreciated, an attribute is a characteristic or property that describes a corresponding entity, such as a name, title, setting, configuration, or other data field. Stated differently, an entity or entity type is the source dataset structure and the attribute is information that belongs to the entity.

Each of the context providers includes logic to select, from among a plurality of potential contexts, relevant context for a corresponding entity and entity type. The context providers can be customized for the associated entity type (e.g., provide by the vendor “out-of-the-box”) or generic irrespective of entity type. In the former case, the context provider's logic is based on the known set of data structures associated with the corresponding entity type. For instance, a feature entity type has a known set of fields, comments, user stores, and other data structures that can be processed using predetermined logic. In the latter case, the context provider logic identifies relevant context based on a lookup perimeter. The lookup perimeter defines a level of context relevancy based on a number of hops of an entity in the unified context graph from the selected one or more entities. Each customized or generic context provider typically has a corresponding description of the logic's application, operation, and capabilities (e.g., what information it can provide, what problems it can solve, etc.) in connection with identifying relevant selected entity context.

The entities can include one or more features, releases (e.g., software release), user stories (e.g., user reports or requests or other container of work), defects (e.g., software defects or virus susceptibilities), test runs (e.g., results of software application test runs), and teams (e.g., the product development, management, or maintenance team, the technical team monitoring the monitored software application, and the like). Each of the entities has a corresponding entity type.

The unified context graph includes entity vectors, with each entity vector including embeddings describing a context associated with a corresponding entity, and attribute vectors, with each attribute vector comprising embeddings describing a context associated with a corresponding entity attribute. The context associated with the corresponding entity can, for example, include a title, description, and/or executable test script. The unified context graph maps the plurality of context providers to an entity type associated with each of the plurality of entities. In the unified context graph, each of the context providers has a corresponding description regarding the respective logic as noted above.

The unified context graph can, for example, include, for a first entity vector embedding, directly related entity vector embeddings, the relationship being based on one or more of graph proximity of a selected entity vector embedding to the first entity vector embedding, a time stamp associated with the selected entity vector embedding, and a level of uniqueness of the selected entity vector embedding relative to other entity vector embeddings.

By way of example, the context can be generated from a Behavior Driven Development (BDD) specification for an application from an Application Lifecycle Management (ALM) system. The BDD specification includes an executable script defining features for the application and scenarios. Each scenario represents a test for one or more features of the application, and each feature can include one or more user stories.

The LM selects the first set of context providers based on the embedded context associated with each of the selected entities and entity types associated with each of the selected entities. The first set of context providers includes a subset of the context providers.

The embedding model determines the second set of relevant context providers using cosine similarity of the attribute vector to context provider vector embeddings describing the corresponding title and description of the context provider. The second set of relevant context providers can also be determined using cosine similarity of the vector embeddings of directly related entities to context provider vector embeddings describing the corresponding description of the context provider. Variations of this approach can be used such as time stamp and/or context weighted cosine similarity techniques.

Using the first and second sets of context providers, the system traverses a graph or unified context database comprising data structures associated with the selected entities and related entities to generate a virtual document including the context associated with the selected entities.

The virtual document can be used in a prompt to an LM to determine a response to the user request.

The present disclosure can address various technical problems.

For example, context information may not be in the form of a structured document, such as a PDF or Word™ document, but in the form of entities, records and relationships in a graph database as typically encountered in ADM applications.

In the ADM domain in particular most of the context information is not structured as documents. Information is structured through entities and relationships. Examples include:

Release: to have a coherent understanding of a release, the related backlog items, tests, etc., are required.

Feature: to have a coherent understanding of a feature, the related requirements, user stores, tests, etc., are required.

Test: to have a coherent understanding of a test, the related requirements, feature and user stories, etc., are required.

Defect: to have a coherent understanding of a defect, the related feature, user stories, tests, etc., are required.

A feature definition for a feature entity can be in the form of a set of attributes, such as a title and description and be related to a test, defect or user story. It can also have related attachments or files or other inputs.

Existing LLMs are often unable or have difficulty identifying the relevant context in information structured in this manner.

To complicate matters, data continuously changes in run time (vs. a final document) and requires retrieving the most up-to-date data for the context and up-to-date vector generation for the RAG.

There is a challenge to understand the meaning of local code names and terms. It is common to have code names for product releases (e.g., names of stars, bands, sports clubs, etc.), for application modules, etc. Finding the relevant context requires understanding the meaning of code names.

Thus, the common RAG is not sufficient, and a specialized business logic is required to generate the information to represent each entity for an optimized context and is part of the prompt template—in other words, a virtual document is generated ad hoc to represent the entity.

Another technical problem is determining the right amount of relevant context information. Too little context information may omit valuable information, while too much may generate noise and increase operational costs. Context information should be optimal for each prompt in relevancy and size.

Another technical problem is determining relevant context information from both static and dynamic context. Examples of static context includes the expert role (“You are an expert quality assurance engineer”), experience (“You have 10+ years of experience with SAP systems”), industry (“You work in the healthcare organization”), etc., as well as concrete examples (e.g., features and related user stories, SAP (or similar enterprise application) features and related tests, defect criticality assessments, etc.). Examples of dynamic context include retrieving per prompt the relevant information from the ADM products and external tools. For example, to answer the request to identify the risks for a selected release at a certain time, the context should include all the high/critical defects, the in-process backlog items, the test coverage, similar other releases risk evaluation, etc.

The present disclosure uses a number of technical solutions to address these technical problems.

The system maps, semantically and through graph proximity, context providers to corresponding entities and attributes. It extends and correlates the entity graph or graph database with a vector database to form the unified context graph database.

The system employs an LM and embedding model to provide the first and second sets of context providers, respectively. The system uses prompt engineering to craft a specific, well-structured, enhanced prompt to guide the LLM in searching the unified context database to determine the first set of context providers. The system uses a modified form of RAG and an embedding model based on entity attributes and directly related entities to search through the unified context database and provide an enhanced second LM response in the form of the second set of context providers. The combination of prompt engineering in the LLM prompt and modified RAG mechanism can provide the optimal prompt and context for an optimal result.

For example, the system can generate the substantially optimized context for each prompt in relevancy and size by retrieving the most relevant context providers according to the specific given request by a combination of crafting a first prompt to an LLM to obtain LLM recommended optimized context providers and using of cosine similarity of ad hoc vector embeddings of relevant context provider descriptions relative to ad hoc vector embeddings of directly related entities and selected entity attributes based on graph proximity. The prompt template can include not only static context but also dynamic context.

Using the first and second sets of relevant context providers, the system generates dynamic virtual documents converting the complex entity graph, or unified context graph, into a document. The virtual documents are used as context for prompts to a LM to determine a reply to the user input or request. This system thereby generates the optimized context for the user request and balances the amount of context information provided in the LM prompt. This approach recognizes that providing a well-crafted prompt having an appropriate amount of context information acts as a guide, helping the LM generate more accurate, relevant, and useful responses. It can be thought of as providing a human expert with more information about a problem—the more relevant details they have, the better they can apply their expertise to find a solution.

The technical solution can address the shortcomings of RAG. In a common RAG implementation, the data is prepared upfront, chunked, and embedded. Then in response to a user request relevant data is retrieved ad hoc and added as a context to the prompt. By contrast, the system enriches the context with dynamic information achieved through a modified RAG mechanism. The system handles data that continuously changes in run time by retrieving the most up-to-date data for the context and up-to-date vector generation. By using semantic embedding in numerical vectors, the system can understand the meaning of local code names and terms. In this manner, context using local code names and terms can be included in the prompt template.

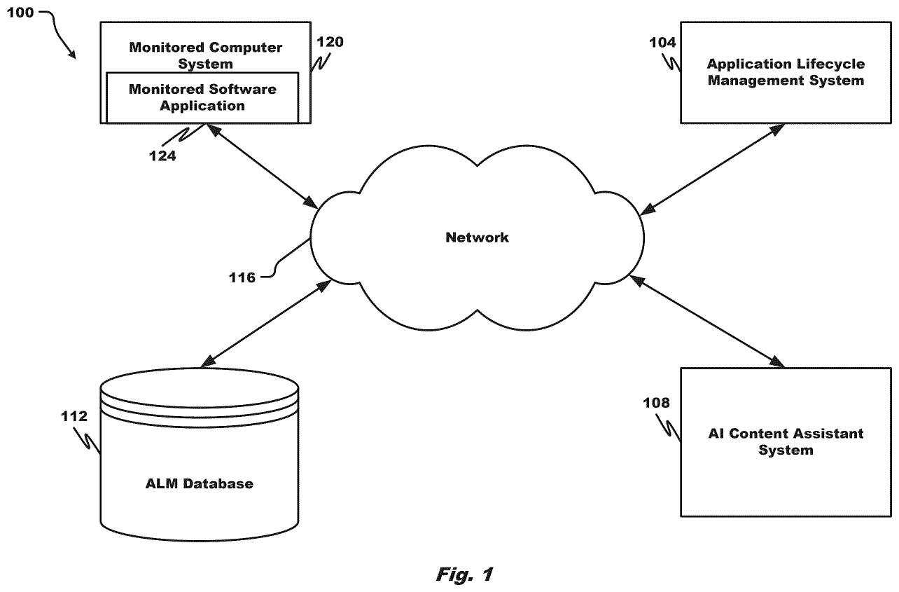

Referring now to FIG. 1, an application management system 100 according to an embodiment is depicted. The system 100 includes an Application Lifecycle Management (ALM) system 104, AI content assistant system 108, and ALM database 112 in communication by network 116 with a monitored computer system 120 comprising, in memory and monitored software application 124.

The ALM system 104 is a computational system that monitors the entire lifecycle of the software application 124 and includes tools for agile, development operations, quality and performance management (e.g., tools that can monitor application health, generate, provide and cause execution of test scripts, identify vulnerability risks and defects, and perform other monitoring operations) and stores the monitored data in connection therewith in the ALM database 112. In some embodiments, the ALM system 104 is a modified form of ValueEdge™ or Agile™\ by OpenText. The ALM system 104 comprises one or more general purpose computers capable of executing programs or scripts. The ALM system may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The ALM system may execute one or more application server(s) and/or database server(s), including without limitation those commercially available from Oracle®, Microsoft®, Sybase®, IBM® and the like, which can process requests from database clients. The web pages created may be forwarded to a computing device, such as the monitored computer system or a computer system of a user via a web (file) server. Similarly, the web server may be able to receive web page requests, web services invocations, and/or input data from a computing device and can forward the web page requests and/or input data to the web (application) server.

The AI content assistant system 108 is a content manager that can act as an intelligent assistant to assist users in finding information, summarize documents, generate content, and automate tasks using natural language. In some embodiments, it uses one or more large language models or LLMs to enable conversation search, summarize documents, and discover information within enterprise content repositories. In some embodiments, the AI content assistant 108 is a modified version of Aviator AI™ by OpenText.

The ALM database 112 may reside in a variety of locations. By way of example, database 112 may reside on a storage medium local to (and/or resident in) the ALM system 104. Alternatively, it may be remote from the ALM system 112. The database 112 may reside in a Storage-Area Network (SAN) familiar to those skilled in the art. The database 112 may be a relational database, such as Oracle 20i®, that is adapted to store, update, and retrieve data in response to Structured Query Language (SQL) formatted commands.

The monitored computer system 120 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. Alternatively, the computer system 120 may be any other electronic device, such as a thin-client computer, Internet-enabled mobile telephone, and/or personal digital assistant, capable of communicating via the network 116 and/or displaying and navigating web pages or other types of electronic documents.

The software application 124 may be any of a variety of applications, including for example, database client and/or server applications and web browser applications.

The network 116 may be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 116 may be a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

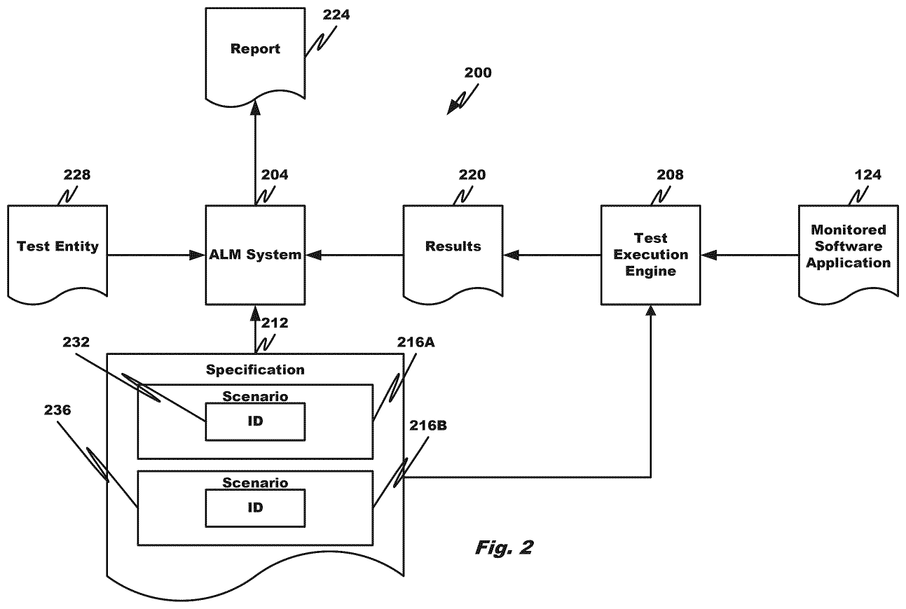

FIG. 2 is a block diagram illustrating elements of an exemplary application lifecycle management system according to one embodiment of the present disclosure. As illustrated in this example, an environment 200 as may be implemented on any one or more of the servers or other computing systems described above can include an Application Lifecycle Management (ALM) system 204. The environment 200 can also comprise a test execution engine 208 adapted to execute one or more tests on the monitored software application 124 according to a specification 212 for the application. For example, the specification 212 can comprise a Behavior Driven Development (BDD) specification. Such a specification can comprise an executable script written in a language such as Gherkin syntax, that enables execution by the test execution engine 208, e.g., using the Cucumber library. The specification 212 can comprise a number of scenarios 216A and 216B. The scenarios 216A and 216B can each define one or more tests, such as functional tests of one or more features of the application 124 for example, executed on the application 124 by the test execution engine 208 through a user interface (not shown here) of the application 124. Such functional tests can further comprise one or more user stories as known in the art. Upon execution of one or more of the scenarios 216A and 216B, the test execution engine 208 can provide results 220 which the ALM system 204 can use to generate a report 224 as will be described below.

According to embodiments described herein, the ALM system 204 can be adapted to synchronize the specification 212 for the application 124 to results 220 of a test of the application 124. More specifically, the ALM system 204 can receive the specification 212 for the application 124 and analyze the specification 212 to identify each scenario 216A and 216B and user story for each feature of the application 124. The ALM system 204 can then create a test entity 228 for and corresponding to each scenario 216A and 216B of the plurality of scenarios in the specification. Each scenario 216A and 216B in the specification 212 can be marked with a test IDentifier (ID) 232 and 236. The test ID 232 and 236 can link the created test entity 228 to the corresponding scenario 216A and 216B in the script of the specification 212.

The script of the specification 212 can be executed by the test execution engine 208 thereby performing one or more of the scenarios 216A and 216B in the specification 212 and results 220 of execution of one or more scenarios 216A and 216B can be received or determined by the ALM system 204. The received results of the execution of the one or more scenarios 216A and 216B can then be provided by the ALM system 204, e.g., in the results report 220, on a per-feature and per-scenario basis. Reporting on a per-feature and/or per-scenario basis can comprise providing indications of whether the script for the feature or scenario has changed since the last execution, whether the script for the feature or scenario executed by the test execution engine 208 is the latest version of that script, whether the script executed by the test execution engine 208 is a new script, and/or an automation status of the test executed by the test execution engine 208.

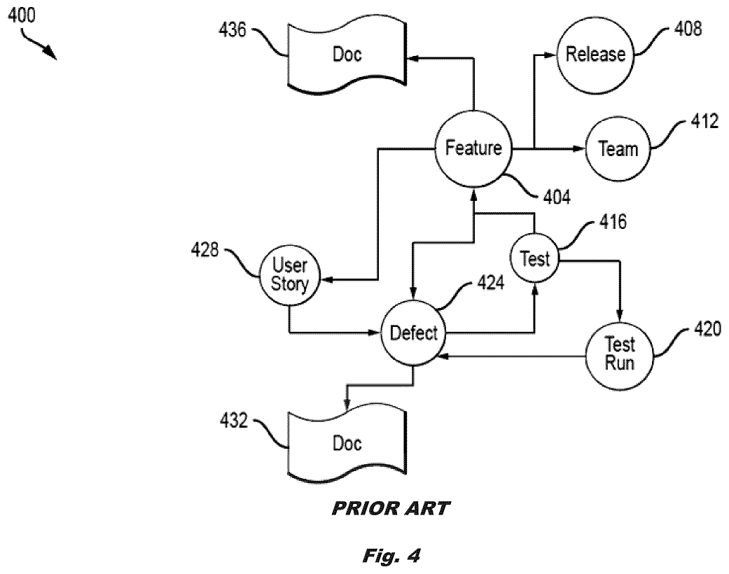

Referring to FIG. 4, an exemplary prior art set of data structures in the ALM database 112 is provided. The data structures 400 are in the form of a graph database and comprise a monitored software application feature 404 related to a monitored software application release 408, monitored software application team 412, a monitored software application test 416, a monitored software application test run 420, a monitored software application defect 424 (e.g., identified by the test run), user story 428, document 432 associated with the feature, and document 436 associated with the results 220.

As can be seen from FIG. 4, the ALM data structures are configured as NoSQL or non-relational database that uses nodes (or entities) (which contain attributes of the entity) and edges (which store information defining the relationships between nodes as shown by the interconnecting lines) to store and query the highly connected data). While a graph data structure is shown, other types of non-relational databases may be employed. The data structures are typically not a relational database in which the connections are inferred by keys.

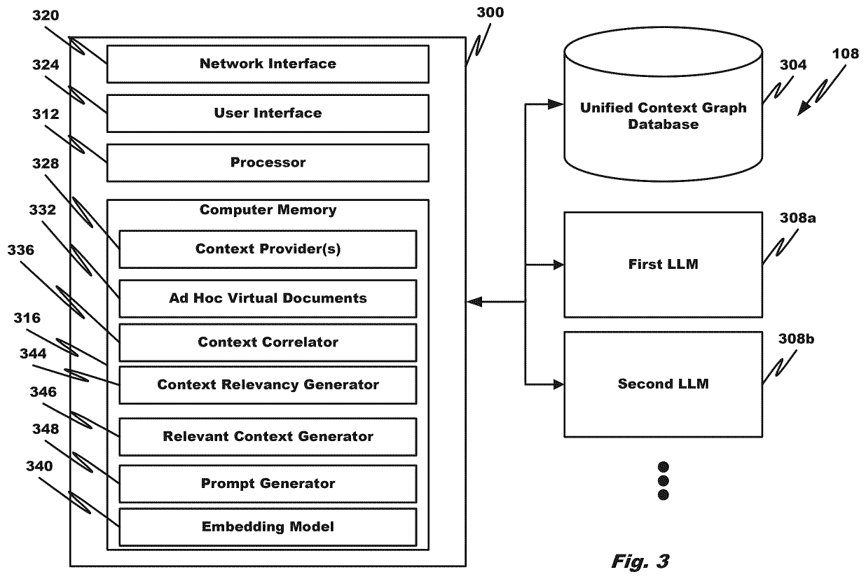

Referring to FIG. 3, an embodiment of the AI content assistant 108 will be described.

The AI content assistant system 108 includes an AI content assistant 300 in communication with a unified context graph database 304, and first, second, . . . LLMs 308a, b, . . . .

The AI content assistant 300 is further shown to include a processor 312, a memory 316, a network interface 320, and user interface 324. These resources may enable functionality of the AI content assistant 300 as will be described herein. For example, the network interface 320 provides the AI content assistant 300 with the ability to send and receive communication packets or the like over the communication network 116. The network interface 320 may be provided as a network interface card (NIC), a network port, drivers for the same, and the like. Communications between the components of the AI content assistant 300 and other devices connected to the communication network 116 may all flow through the network interface 320.

The user interface 324 may correspond to any type of input and/or output device that enables a user to interact with the AI content assistant 300, such as via text or voice.

The processor 312 may correspond to one or many computer processing devices. For example, the processor 312 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 312 may be provided as a microprocessor, Central Processing Unit (CPU), or plurality of microprocessors that are configured to execute the instructions sets stored in memory 316. Upon executing the instruction sets stored in memory 316, the processor 312 enables various authentication functions of the AI content assistant 300.

The memory 316 may include any type of computer memory device or collection of computer memory devices. The memory 316 may be volatile or non-volatile in nature and, in some embodiments, may include a plurality of different memory devices. Non-limiting examples of memory 316 include Random Access Memory (RAM), Read Only Memory (ROM), flash memory, Electronically-Erasable Programmable ROM (EEPROM), Dynamic RAM (DRAM), etc. The memory 316 may be configured to store the instruction sets depicted in addition to temporarily storing data for the processor 312 to execute various types of routines or functions. Although not depicted, the memory 316 may include instructions that enable the processor 312 to store data to and retrieve data from the unified context graph database 304 and/or ALM database 112.

In some embodiments, the context provider instruction sets 328, when executed by the processor 304, may enable the AI content assistant 300 to traverse the database of FIG. 4 for a selected entity and generate an ad hoc virtual document 332 comprising relevant context.

The context provider can be in the form of logic customized for a specific entity type, such as features, user stories, tests, defects, etc., that encompass prior knowledge and best practices. For example, for a selected feature, the content provider includes all of its related user story entities but there is no need to include the user story tasks details. In a further example, to propose new tests for a feature, the content provider can include tests from similar features (e.g., using similarity analysis capabilities). By that generation, time is optimized and the generated document does not include data that can be considered as “noise” to the LLM and increase costs due to prompt size. Each customized context provider can come with a predefined description in natural language that describes its main skills and capabilities. The description is next used for semantically searching relevant context providers. Description examples for feature entity type context providers include:

SPECIFICATIONS—the description of the feature and contains the specifications for the feature and describes the requirements, and optionally background, customer stories, use cases, and motivation.

FIELDS—the feature fields, mostly categorical and numerical and includes additional information on the feature's users involved, timing (creation, modification), phase of development, priority, release, sprint, effort estimation, and others.

COMMENTS—the comments that various users wrote on the feature. Comments may contain some extra information that is not mentioned in the feature description and were added as a question and answer or as an afterthought.

STORIES—the user stories of the feature. It includes a breakdown of the feature into similar implementable tasks. It may also include quality stories describing the various quality tasks that need to be performed as part of the feature.

ISSUES—the bugs and quality issues that were found in the feature. The user may also refer to them as defects.

The context provider can be in the form of generic (naïve) logic that is generic for all entity types. The context provider's logic is given a lookup perimeter (defining a relevancy window) over the selected entity graph (1-N). It will first add the selected entity attributes to the generated document and next recursively traverse the graph to the next related entity (e.g., distance of 1 hop) to add them to the document and so forth up to the perimeter size. For example, when a selected feature is the selected entity and the perimeter value is set to “0”, the document will include only the feature's attributes. When the perimeter value set to “1”, the document will additionally include all the feature's related user stories, defects, tests, etc., as shown in FIG. 4.

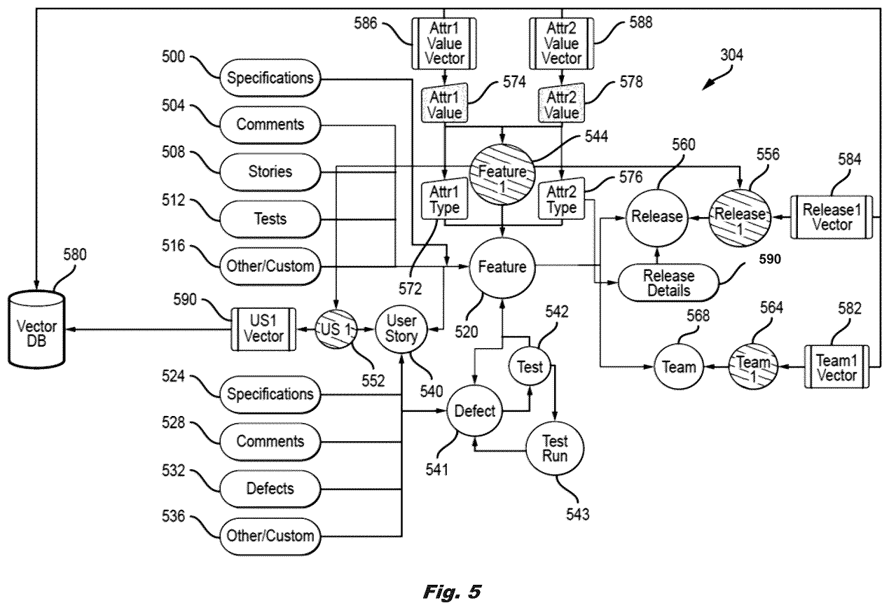

In some embodiments, the context correlator instruction set 336, when executed by the processor 304, may enable the AI content assistant 300 to map semantically and through graph proximity context providers to entities and attributes and thereby extend and correlate the entity graph of FIG. 4 with a vector database to form the unified context graph of FIG. 5. In some embodiments, the graph database of FIG. 4 is prepopulated with entity types, entities, their attributes, and relationships. The context correlator instruction set 336 relates each of the customized context providers to a respective entity type in the graph database as well as predetermined or prepopulated attributes. The custom context providers can be with the product when uploaded and/or added into an environment by a user and related to entity types. When a custom context provider is added to the graph database, its respective description vector is generated by the embedding model 340 (discussed below). In test run time as entities and attributes are added, each is related to its respective type in the graph database. On prompt time, ad hoc vectors are generated for the relevant entities and attributes as discussed below.

In some embodiments, the context relevancy generator instruction set 344, when executed by the processor 304, may enable the AI content assistant 300 to generate the substantially optimized context for a given user request by reviewing the most relevant context providers according to the specific given request using a combination of LLM recommended substantially optimized context providers (e.g., the first set of relevant context providers) and embedding model 340 recommended substantially optimized context providers (e.g., the second set of relevant context providers). As discussed below, the embedding model 340 can use graph proximity to select substantially optimized context providers, such as by comparing ad hoc value vectors of entities and attributes using graph proximity techniques, such as cosine similarity, Euclidean distance, and the like.

In some embodiments, the relevant context generator instruction set 344, when executed by the processor 304, may enable the AI content assistant 300 to determine, for each selected entity and from each of the relevant context generators in the first and second sets of context generators for that entity and based on the unified context graph, relevant context to be included in an LLM prompt.

An example of the output of the relevant context generator for feature ID 1514223 and Feature EPIC as the selected entities is as follows:

```
feature ID: 1514223,
  feature name: [Automation] phase 2 - enhancements for common functionality.
  Today date: November 10, 2024 at 09:00:09 AM UTC
  ***FEATURE SPECIFICATIONS***
  - section description:
  The description of the feature, contains the specifications for this feature and describes the
requirements, and sometimes also contains background, customer stories, use cases, and
motivation.
- data:
  - Description: We want to have all current relevant automation quality stories to
  be handled in a concentrated effort
***FEATURE EPIC***
  - section description:
  The parent of the feature is epic which is a higher-level entity in our application lifecycle
management system. This entity represents a broader goal or objective, under which multiple
features, including ours, are developed.
- data:
  - Parent name: ‘[Automation Focus FY22] Regression coverage’
  Description:
```

In some embodiments, the prompt generator instruction set 348, when executed by the processor 304, may enable the AI content assistant 300 to generate LM prompts to a selected one of the first, second, . . . LLMs 308a, b, . . . . The prompt generator instruction set 348 can use prompt engineering techniques to formulate a substantially optimal prompt for the desired response. For example, the prompt provided to the LLM to determine the first set of relevant context providers typically includes, for each selected entity and user request, optimized context provider titles and descriptions associated with each selected entity and requests the LLM which context providers are the most relevant (with the response being top X configurable). That is, the prompt requests the LLM to add the most relevant context providers to a list of relevant context providers for the selected entities, such as, for a first entity, first, second, and third relevant context providers and, for a second entity, fourth, fifth and sixth relevant context providers.

An example of the prompt to the LLM to determine the first set of relevant context providers for user request and selected entity in the user request is provided below:

```
context prompt:
You are an application lifecycle expert who uses an advanced ALM system.
  A user asks you a question about a feature, and you should determine what data that relates to this feature you need from
the ALM system to answer the user's question.
  To be able to answer the user, you can choose up to four of the following contexts the ALM system can provide.
  Read the user question carefully, and tell me which of the contexts below you need to answer the user's question:
possible contexts:
  1. SPECIFICATIONS - the description of the feature, contains the specifications for this feature and describes the
requirements, and sometimes also contains background, customer stories, use cases, and motivation.
  2. FIELDS - the feature fields, mostly categorical and numerical including additional information on the feature's users
involved, timing (creation, modification), phase of development, priority, release, sprint, effort estimation, and many more.
  3. COMMENTS - the comments that various users wrote on that feature. Comments may contain some extra information
that isn't mentioned in the feature description and was added as a question and answer or as an afterthought.
  4. STORIES - the user stories of this feature. It includes a breakdown of this feature into smaller implementable tasks. May
also include quality stories describing the various quality tasks that need to be done as part of this feature.
  5. ISSUES - the bugs and quality issues that were found in this feature. The user might also refer to them as defects.
  6. TESTS - the tests that are covering the feature specification and contain information on how this feature is being tested.
  7. AFFECTED_AREAS - (also identified as ′affected′);
  8. ACCEPTANCE_CRITERIA - (also identified as ′acceptance′); Criteria for the PM/PO to accept the feature as completed
  9. WHAT’S_NEW_TEXT - (also identified as ′whats′); Content of What's New description of feature when What's New is
relevant
  10. THREAT_MODELING_(TM)_OUTCOME - (also identified as ′security′); Evidence from Threat Modeling, ideally table of
threats
First, do step-by-step reasoning and then answer by giving an array as in the examples below.
Also, take into consideration the following information during the reasoning process:
  Besides the generic contexts (whose names are SPECIFICATION, FIELDS, COMMENTS, STORIES, ISSUES, TESTS),
there can be some additional contexts which are not generic. These additional contexts are used to reply to questions which
seems to be related to their name (and to their description if it's provided). Generic contexts can be also included if a part of
the questions is also related to them.
  please follow the format in the examples, your final answer must have the formal ‘‘‘json(″contex_list″:)‘‘‘
```

In the above prompt example, the possible contexts each correspond to a context provider shown in FIG. 5 below.

An exemplary LLM response to the prompt example is shown below.

```
-user_question: What original requirements led to the creation of this feature?
  -rephrase: I want you to bring data that explains to me why the feature was created!
  -step_by_step_reasoning: the user's question is related to the general specification of the feature, which is most likely
found in the ′SPECIFCATION′ context.
  ‘‘‘json(″context_lit″:[″SPECIFICATIONS″])‘‘‘
-user_question: Give me tests that covered the feature's functionality?
  -rephrase: I want you to suggest new tests for the feature!
  -step_by_step_reasoning: the feature's main functionality is in the ′SPECIFICATIONS′ context, so to cover it by tests I need
to bring the ′SPECIFICATIONS′ however I also need to know which tests already exist in the system, so I will not create
tests that already exist, so I need to bring the ′TESTS′ context as well
  ‘‘‘json(″context_list″;[″SPECIFICATIONS″,″TEST″])‘‘‘
-user_question: Who has been responsible for the updates to this feature over the past month?
  -rephrase: I need to know the person who updated the feature in the past month!
  -step_by_step_reasoning: The query is focused on identifying the person or team responsible for recent updates, this type
of user involved in the feature is related to the ‘FIELDS’ context
  ‘‘‘json(″context_list″:[″FIELDS″])‘‘‘
-user_question: What are the latest discussions or concerns raised about this feature?
  -rephrase: Bring me the data that relates to the concerns raised by people regarding the feature!
  -step_by_step_reasoning: The discussions are probably found in the ‘COMMENTS’ context, but without the
′SPECIFICATIONS′ it will be very hard to understand the context in which the comment has been written
  ‘‘‘json(″context_list″:[″SPECIFICATION″,″COMMENTS″])‘‘‘
-user_question: Which user stories needed to be added to the feature?
  -rephrase: Create the user stories that are missing on the feature
  -step_by_step_reasoning: in order to know if I need to ad user stories, I need to know the user stories that already exist to
I will bring the ′STORIES′ context, however, I also need to know the ′SPECIFICATIONS′ context to identify the gap between
the specification and the current stories, also ′COMMENTS′ context may contain information about some missing
functionality
  ‘‘‘json[″context_list″:[″SPECIFICATIONS″,″COMMENTS″,″STORIES″])‘‘‘
```

Likewise, the prompt generation instruction set 348 can generate a prompt for an LLM reply to the user request by including in the prompt the user request, optionally first and second sets of relevant context providers, relevant context provided by the first and second sets of relevant context providers, and additional context information.

In exemplary prompt for an LLM reply to the user request is shown below.

```
Your role: You are a helpful AI assistant specialized in guiding users to efficiently utilize their software
lifecycle data and processes. You provide clear and detailed explanations, but do not directly modify
the system or its entities.
  Your task: When presented with a user request you must provide a comprehensive response after
carefully reading the data.
  Ensure your answer is detailed, professional, and well-reasoned. Include relevant specifics and clear
explanations to support your answer.
  Remember: You cannot make actual changes to the system. Your role is to provide information,
explanations, and guidance only.
<context_data>
  feature ID: 1514223,
  feature name: [Automation] phase 2 - enhancements for common functionality.
  Today date: November 10, 2024 at 09:00:09 AM UTC
  ***FEATURE SPECIFICATION***
  - section description:
  The description of the feature, contains the specifications for this feature and describe the
requirements, and sometimes also contains background, customer stories, use cases, and motivation.
- data:
  - Description: We want to have all current relevant automation quality stories to
  be handled in a concentrated effort
***FEATURE EPIC***
  - section description:
  The parent of the feature is epic which is a higher-level entity in our application lifecycle management
system. This entity represents a broader goal or objective, under which multiple features, including
ours, are developed.
- data:
  - Parent name: ″[Automation Focus FT22] Regression coverage″
  Description:
</context_data>
<chat_history>
</chat_history>
<request>
  Hi. How are you?
</request>
your final answer should be in English
The final answer of the request, should be in the following json format
  the final answer inside the json must be valid markdown
  you must use escape characters for invalid characters inside the json
  ‘‘‘json(″final_answer″:″<the final answer>″)‘‘‘
```

The above prompt contains relevant context for each of the selected features Feature ID 1514223 and Feature EPIC, which relevant context includes not only data but also chat history.

In some embodiments, the embedding model instruction set 340, when executed by the processor 304, may enable the AI content assistant 300 to translate complex data, such as attribute values and descriptions and other information relating to context providers, entities, edges, and attributes, into dense lists of numbers (vectors) that capture their meaning and relationships, allowing a processor to understand and process them mathematically for tasks like search, recommendation, and classification by placing similar items close together in a multi-dimensional space. These models create “digital fingerprints” (embeddings) where semantic meaning becomes proximity, enabling AI to find patterns and perform tasks that require understanding context, not just keywords. The embedding model can comprise transformation instructions to convert high dimensional raw data into a fixed length vector, vector embeddings, or array of numbers in lower dimensional space, semantic representation instructions to position the vector in a high-dimensional space to reflect the data's meaning such that similar items have vectors that are close to each other, and mathematical operation instructions to use vector math (e.g., cosine similarity, Euclidean distance, etc.) to measure closeness and compare data points. The embeddings can be any type of embeddings, such as word embeddings, sentence embeddings, image embeddings or graph embeddings.

The unified context graph database 304 in FIG. 5 is a type of knowledge graph that combines disparate data sources into a single, interconnected framework of entities, relationships and context. Referring to the example of FIG. 5, the unified context graph database 304 maps context providers to a corresponding entity (e.g., specification context provider 500, comments context provider 504, stories context provider 508, tests context provider 512, and other/custom context provider 516 are mapped to the feature entity type 520 and specification context provider 524, comments context provider 528, defects context provider 532, and other/custom context provider 536 are mapped to the user story entity type 540). Other entity types include defect entity type 541, test entity type 542, and test run entity type 543. An instance of the feature, or first feature 544, is related directly to the feature entity type 520, an instance of the user story, or first user story 552, is related directly to the user story entity type 540, an instance of the release, or first release 556, is related directly to the release entity type 560 (having associated release details 590), and an instance of the team, or first team 564, is related directly to the team entity type 568. Moreover, attribute types are related directly to a corresponding instance of the attribute type as shown by the direct relationship between the attribute 1 type, or first attribute type 572, and an instance of the first attribute type, or first attribute value 574, and between the attribute 2 type, or second attribute type 576, and an instance of the second attribute type, or second attribute value 578. The unified context graph database 304 further includes vector embeddings from the vector database 580 for attribute values and for entity instances as shown by the first team vector 582 corresponding to the first team 564, the first release vector 584 corresponding to the first release 556, the first attribute value vector 586 corresponding to the first attribute type 574, the second attribute value vector 588 corresponding to the second attribute type 578, and the first user story vector 590 corresponding to the first user story 552.

The vector database stores, indexes, and searches vector embeddings generated by the embeddings model instruction set. When the vector database is searched, the search query is converted by the embeddings model instruction set into a vector embedding to enable the database to quickly find other vectors, such as by cosine similarity or Euclidean distance techniques.

The first, second, . . . LLMs 308a, b, . . . in the LLM array can be any type of LLM and can be trained on different datasets and have different knowledge and capabilities. As will be appreciated, a large language model (LLM) is a type of artificial intelligence (AI) algorithm that uses deep learning techniques and massively large data sets to understand, summarize, generate and predict new content. LLMs are a type of generative AI that has been specifically architected to generate text-based content. The architecture of LLMs commonly includes multiple layers of neural networks, e.g., recurrent layers, feedforward layers, embedding layers, and attention layers. LLMs are commonly configured as artificial neural networks which can contain a billion to a trillion weights and are typically (pre-) trained using self-supervised and/or semi-supervised learning. A transformer architecture can enable faster training. Alternative architectures include a mixture of experts (MoE). The large size of LLMs can be enabled by AI accelerators, which are able to process vast amounts of text data, mostly scraped from the Internet. These layers work together to process the input text and generate output predictions. While any LLM can be used with this disclosure, LLM examples include OpenAI's GPT models (e.g., GPT-3.5 and GPT-4, used in ChatGPT), Gemini, Gemma, and LLaMa3, Claude 3, Phi3, etc.

Dataset pre-processing can use probabilistic tokenization. Using a modification of byte-pair encoding, in the first step, all unique characters (including blanks and punctuation marks and other grammar indicators) are treated as an initial set of n-grams (i.e. initial set of uni-grams). Successively the most frequent pair of adjacent characters is merged into a bi-gram and all instances of the pair are replaced by it. All occurrences of adjacent pairs of (previously merged) n-grams that most frequently occur together are then again merged into even lengthier n-gram repeatedly until a vocabulary of prescribed size is obtained (in case of GPT-3, the size is 50257). Token vocabulary consists of integers, spanning from zero up to the size of the token vocabulary. New words can always be interpreted as combinations of the tokens and the initial-set uni-grams.

The various LLMs in the LLM array are typically different from one another. The differences include one or more of model size and parameter account, input representations, self-attention mechanisms, training objectives, computational efficiency, training methodology and training data, and decoding and output generation. In some embodiments, the LLMs are open or closed source LLMs, general-purpose LLMs, domain-specific LLMs, multilingual LLMs, few-shot LLMs, and/or task-specific LLMs.

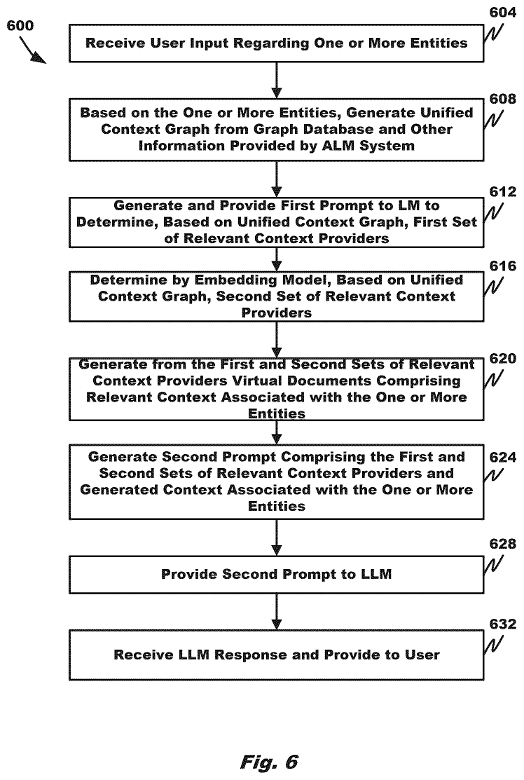

FIG. 6 illustrates an example of a process flow 600 that supports aspects of the present disclosure associated with providing an LLM response to a user request. In the following description of the method 600, the operations may be performed in a different order than the order shown, or the operations may be performed in different orders or at different times. Certain operations may also be left out of the process flow 600, or other operations may be added to the process flow 600. It is to be understood that any computational device may perform the operations shown.

Referring now to FIG. 6, a method 600 of processing a user request and providing an LLM response will be described in accordance with embodiments of the present disclosure. The method begins when the AI content assistant system 108 receives a natural language user request comprising one or more entities and attributes and optionally a selected screen display and chat history (step 604). The AI content assistant system 108 analyzes the inputted information from the user and generates a list of selected entities and/or attributes. For example, these can be selected directly in the request and/or user interface screen display (such as a list of entities in focus) and/or in the chat history (such as the entities in the previous request).

In some configurations, the AI content assistant system 108 supports power actions. A power action reflects a common expected user request (e.g., break down a feature into user stories, generate tests for a selected feature, and the like), with an optimized or predetermined response defined based on prior user interactions.

In some configurations, the AI content assistant 108 identifies selected entities from the user request with no need for explicit entity user selection by using the embedding model 340 to generate vector embeddings of the user request followed by measuring the similarity between the vector embeddings and selected vector embeddings for entities and attributes, such as using cosine similarity and Euclidian distance. As will be appreciated, cosine similarity is a metric that measures how similar the direction of two non-zero vectors is in a multi-dimensional space. It is calculated as the cosine of the angle between them, yielding a value from a value of “−1” (meaning they are opposite) to “1” (meaning they are identical), with a “0” meaning they are orthogonal (unrelated). It focuses on orientation, not magnitude, making it suitable for comparing text, images, or user preferences where the size of the data does not matter as much as its pattern. Euclidean or Pythagorean distance calculates the straight-line distance between two points in Euclidean space, with the distance being inversely related to the degree of degree of relevance.

The method 600 may continue the AI content assistant system 108, based on the selected entities or attributes, generating a unified context graph from the graph database and other information provided by the ALM system 104 as discussed above (step 608).

The method 600 may continue by the AI content assistant system 108, generating and providing a prompt to a selected one of the first, second, . . . LLMs 308a, b, . . . to determine, based on the unified context graph, the first set of relevant context providers as discussed above (step 612). Typically, the first set includes a subset of relevant context providers for each selected entity or attribute.

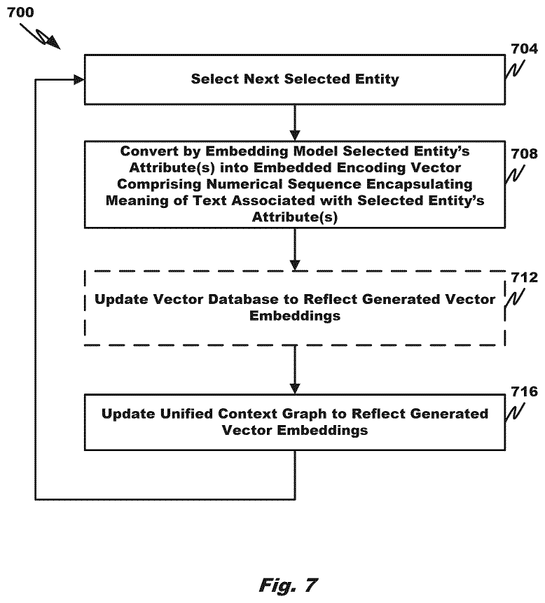

The method 600 may continue by the AI content assistant system 108 determining by the embedding model, based on the unified context graph, a second set of relevant context providers (step 616). Typically, the second set includes a subset of relevant context providers for each selected entity or attribute. This step will be discussed with reference to the method 700 shown in FIG. 7.

FIG. 7 illustrates an example of a process flow 700 that supports aspects of the present disclosure associated with providing the second set of relevant context providers. In the following description of the method 700, the operations may be performed in a different order than the order shown, or the operations may be performed in different orders or at different times. Certain operations may also be left out of the process flow 700, or other operations may be added to the process flow 700. It is to be understood that any computational device may perform the operations shown.

The method 700 begins by the embedding model selecting a next selected entity attribute (step 704).

The method 700 may continue by the embedding model converting the selected entity's attribute into an embedded encoding vector or ad hoc vector comprising a numerical sequence encapsulating the meaning of the text associated with the selected entity's attribute (step 708). The text for an attribute can, for example, be the attribute value. The vector embeddings of the attribute can be compared against vector embeddings corresponding to the description of each context provider to determine relevant context providers.

In some configurations, the embedding model generates vector embeddings or ad hoc vectors for the entities directly related to the selected entity (e.g., a distance of one hop from the selected entity in the unified context graph). For example, for the first feature 544 as the selected entity the directly related entities are the first user story 552, first release 556, and first team 564. The text used to generate the vector embedding for each directly related entity can for example be the entity title and its description attributes. When the directly related entity is a test, the text may further include the test script. The vector embeddings of the entities related directly to the selected entity can be compared against vector embeddings corresponding to the title and description of each context provider to determine relevant context providers.

The method 700 may continue by the AI content assistant system 108 adding at least temporarily the vector embeddings to the vector database 580 by updating the vector database to reflect the generated vector embeddings (optional step 712).

The method 700 may continue by the AI content assistant system 108 updating the unified context graph 304 to reflect the generated vector embeddings (step 716).

The method 700 may continue by returning to step 704 for a next selected entity or attribute.

Returning to FIG. 6, in step 616 each member of the second set of relevant context providers can be determined, for example, by finding in the vector database or unified context graph for a selected entity the top X most similar vectors to the vector embeddings of the selected entity's attribute and directly related entities through cosine similarity or Euclidean distance techniques. In some embodiments for an attribute vector embedding, the AI content assistant system traverses the unified context graph and finds its related context providers and adds the respective context providers to the second set of relevant context providers. For example, for a feature attribute related to the release details, the feature related release and the release details context are added to the set of relevant context providers. In some embodiments for a directly related entity vector embedding, the AI content assistant system traverses the unified context graph and finds its related context providers and adds the respective context providers to the second set of relevant context providers.

The method 600 may continue by the AI content assistant 108 generating from the first and second sets of relevant context providers virtual documents comprising relevant context associated with the selected entities (step 620).

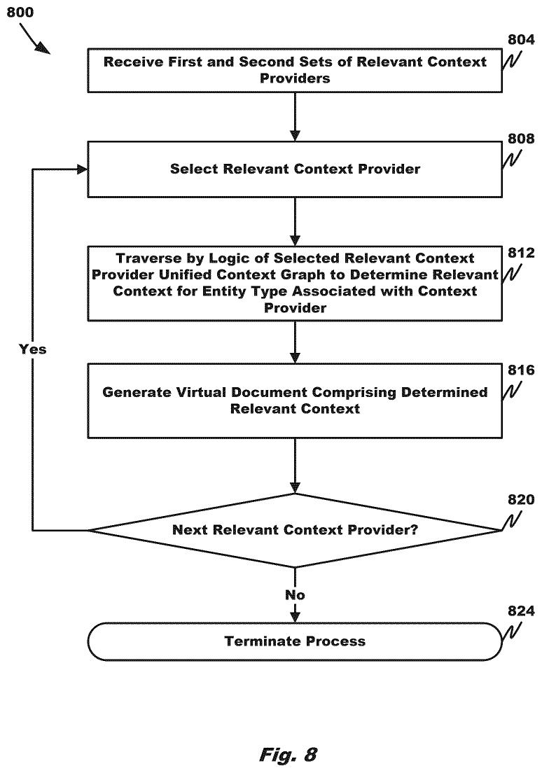

Generation of the virtual documents will be discussed in connection with the method 800 of FIG. 8. FIG. 8 illustrates an example of a process flow 800 that supports aspects of the present disclosure associated with generating a virtual document comprising relevant context from a graph database or the unified context database. In the following description of the method 800, the operations may be performed in a different order than the order shown, or the operations may be performed in different orders or at different times. Certain operations may also be left out of the process flow 800, or other operations may be added to the process flow 800. It is to be understood that any computational device may perform the operations shown.

The method 800 starts by the processor receiving the first and second sets of relevant context providers (step 804).

The method 800 can continue by the AI content assistant 108 selecting from one of the first and second sets a relevant context provider (step 808).

The method 800 may continue by the AI content assistant 108 traversing by the logic of the selected relevant context provider the unified context graph to determine relevant context for the entity type associated with the selected relevant context provider (step 812).

The method 800 may continue by the AI content assistant 108 generating the virtual document comprising the determined relevant context (step 816).

The method 800 may continue by the AI content assistant 108 determining whether there is a next relevant context provider in the first and second sets of relevant context providers (decision diamond 820).

When there is a next relevant context provider, the AI content assistant 108 returns to step 808 and repeats steps 812 and 816, with respect to the next selected context provider.

When there is not a next relevant context provider, the method 800 may continue by the AI content assistant system 108 terminating the process (step 824).

Returning to FIG. 6, the method 600 may continue by the AI content assistant 108 generating a second prompt comprising the first and second sets of relevant context providers and generated context associated with the one or more entities (including the virtual documents generated by method 800).

The method 600 may continue by the AI content assistant system 108 providing the second prompt to one of the first, second, . . . LLMs 308a, b, . . . (step 628).

The method 600 may continue by the AI content assistant system 108 receiving the LLM response and providing the response to the user as a reply to the user request (step 632).

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

What is claimed is:

1. A system comprising:
a user interface;
a processor;
a memory coupled with and readable by the processor and storing therein a set of instructions which, when executed by the processor, cause the processor to:
provide a unified context graph mapping semantically a plurality of context providers to corresponding entities and/or attributes, each entity being related to one or more of the attributes;
receive, by the user interface, user input selecting one or more entities;
provide a first prompt comprising the selected one or more entities to a language model (LM) to determine, based on the unified context graph and from among the plurality of context providers, a first set of relevant context providers;
transform, by an embedding model, an attribute of the selected one or more entities into an attribute vector embedding semantically describing the attribute;
compare the attribute vector embedding with vector embeddings associated with the plurality of context providers, to determine a second set of relevant context providers different from the first set of relevant context providers;
generate, from the first and second sets of relevant context providers, context associated with the selected one or more entities; and
determine from a second prompt comprising the generated context a LM reply to provide to the user in response to the user input.

2. The system of claim 1, wherein the selected one or more entities comprises a plurality of features, wherein the context is generated from a Behavior Driven Development (BDD) specification for an application from an Application Lifecycle Management (ALM) system, the BDD specification comprising an executable script defining the plurality of features for the application and a plurality of scenarios, each scenario representing a test for one or more features of the plurality of features of the application, and each feature comprising one or more user stories.

3. The system of claim 1, wherein the selected one or more entities comprises a plurality of features, releases, user stories, defects, test runs, and teams, each of the selected one or more entities having an entity type, wherein the unified context graph comprises entity vector embeddings, each entity vector embedding describing a context associated with a corresponding entity, and value vector embeddings, each value vector embedding describing a context associated with a corresponding entity attribute, and wherein the unified context graph maps the plurality of context providers to an entity type associated with each of a plurality of entities.

4. The system of claim 3, wherein the LM selects the first set of the plurality of context providers based on the context associated with each of the selected one or more entities and entity types associated with each of the selected one or more entities, the first set of the plurality of context providers being a subset of the plurality of context providers, wherein each of the plurality of context providers comprises respective logic to select, from among a plurality of potential contexts, relevant context for a corresponding entity and entity type, and wherein, in the unified context graph, each of the plurality of context providers has a corresponding description regarding the respective logic.

5. The system of claim 3, wherein the context associated with the corresponding entity comprises title, description, and test script and wherein the unified context graph comprises, for a first entity vector embedding, a plurality of directly related entity vector embeddings, the direct relationship being based on one or more of graph proximity of a selected entity vector embedding to the first entity vector embedding, a time stamp associated with the selected entity vector embedding, and a level of uniqueness of the selected entity vector embedding relative to other entity vector embeddings.

6. The system of claim 3, wherein each of the plurality of context providers comprises respective logic to select, from among a plurality of potential contexts, relevant context for a corresponding entity and entity type, wherein, in the unified context graph, each of the plurality of context providers has a corresponding description regarding the respective logic, and wherein the embedding model determines the second set of relevant context providers using cosine similarity of the value vector embedding to a context provider vector embedding describing the corresponding description of the corresponding context provider.

7. The system of claim 1, wherein the generating comprises traversing a graph database comprising data structures associated with the selected one or more entities and related entities to generate a virtual document comprising the context associated with the selected one or more entities and wherein the selected one or more entities and related entities comprise a plurality of features, releases, user stories, defects, test runs, and teams.

8. The system of claim 7, wherein, in the unified context graph, each of the plurality of context providers has a corresponding description regarding the context provider's respective logic and wherein the context provider's respective logic, when executed by the processor, identifies relevant context based on a lookup perimeter, the lookup perimeter defining a level of context relevancy based on a number of hops in the unified context graph of an entity from the selected one or more entities.

9. A method comprising:
providing a unified context graph mapping semantically a plurality of context providers to corresponding entities and/or attributes, each entity being related to one or more of the attributes;
receiving, by a user interface, user input selecting one or more entities;
providing, by a processor, a first prompt comprising the selected one or more entities to a first language model (LM) to determine, based on the unified context graph and from among the plurality of context providers, a first set of relevant context providers;
transforming, by the processor, an attribute of the selected one or more entities into an attribute vector embedding semantically describing the attribute;
comparing, by the processor, the attribute vector embedding with vector embeddings associated with the plurality of context providers, to determine a second set of relevant context providers different from the first set of relevant context providers;
generating, by the processor from the first and second sets of relevant context providers, context associated with the selected one or more entities; and
determining, by the processor, from a second prompt comprising the generated context a LM reply to provide to the user in response to the user input.

10. The method of claim 9, wherein the selected one or more entities comprises a plurality of features, wherein the context is generated from a Behavior Driven Development (BDD) specification for an application from an Application Lifecycle Management (ALM) system, the BDD specification comprising an executable script defining the plurality of features for the application and a plurality of scenarios, each scenario representing a test for one or more features of the plurality of features of the application, and each feature comprising one or more user stories.

11. The method of claim 9, wherein the selected one or more entities comprises a plurality of features, releases, user stories, defects, test runs, and teams, each of the selected one or more entities having an entity type, wherein the unified context graph comprises entity vector embeddings, each entity vector embedding describing a context associated with a corresponding entity, and value vector embeddings, each value vector embedding describing a context associated with a corresponding entity attribute, and wherein the unified context graph maps the plurality of context providers to an entity type associated with each of a plurality of entities.

12. The method of claim 11, wherein the LM selects the first set of the plurality of context providers based on context associated with each of the selected one or more entities and entity types associated with each of the selected one or more entities, the first set of the plurality of context providers being a subset of the plurality of context providers, wherein each of the plurality of context providers comprises respective logic to select, from among a plurality of potential contexts, relevant context for a corresponding entity and entity type, and wherein, in the unified context graph, each of the plurality of context providers has a corresponding description regarding the respective logic.

13. The method of claim 11, wherein the context associated with the corresponding entity comprises title, description, and test script and wherein the unified context graph comprises, for a first entity vector embedding, a plurality of directly related entity vector embeddings, the direct relationship being based on one or more of graph proximity of a selected entity vector embedding to the first entity vector embedding, a time stamp associated with the selected entity vector embedding, and a level of uniqueness of the selected entity vector embedding relative to other entity vector embeddings.

14. The method of claim 11, wherein each of the plurality of context providers comprises respective logic to select, from among a plurality of potential contexts, relevant context for a corresponding entity and entity type, wherein, in the unified context graph, each of the plurality of context providers has a corresponding description regarding the respective logic, and wherein the determining of the second set of relevant context providers comprises comparing, by cosine similarity, the value vector embedding to a context provider vector embedding describing the corresponding description of the corresponding context provider.

15. The method of claim 9, wherein the generating comprises traversing a graph database comprising data structures associated with the selected one or more entities and related entities to generate a virtual document comprising the context associated with the selected one or more entities and wherein the selected one or more entities and related entities comprise a plurality of features, releases, user stories, defects, test runs, and teams.

16. The method of claim 15, wherein, in the unified context graph, each of the plurality of context providers has a corresponding description regarding the context provider's respective logic and further comprising identifying, by the processor, relevant context based on a lookup perimeter, the lookup perimeter defining level of context relevancy based on a number of hops of an entity in the unified context graph from the selected one or more entities.

17. A system comprising:
a processor;
a memory coupled with and readable by the processor and storing therein a set of instructions which, when executed by the processor, cause the processor to:
provide a unified context graph mapping semantically a plurality of context providers to corresponding entities and/or attributes, each entity being related to one or more of the attributes, wherein the entities comprises a plurality of features, releases, user stories, defects, test runs, and teams, each of the entities having an entity type, wherein the unified context graph comprises entity vector embeddings, each entity vector embedding describing a context associated with a corresponding entity, and value vector embeddings, each value vector embedding describing a context associated with a corresponding entity attribute, and wherein the unified context graph maps the plurality of context providers to an entity type associated with each of a plurality of entities;
provide a first prompt comprising one or more selected entities to a first language model (LM) to determine, based on the unified context graph and from among the plurality of context providers, a first set of relevant context providers;
transform, by an embedding model, an attribute of the one or more entities into an attribute vector embedding semantically describing the attribute;
compare the attribute vector embedding with vector embeddings associated with the plurality of context providers, to determine a second set of relevant context providers different from the first set of relevant context providers;
generate, from the first and second sets of relevant context providers, context associated with the one or more entities; and
provide a second prompt comprising the generated context to an LM to generate a response to a query regarding the one or more selected entities.

18. The system of claim 17, wherein the entities comprise a plurality of features, wherein the context is generated from a Behavior Driven Development (BDD) specification for an application from an Application Lifecycle Management (ALM) system, the BDD specification comprising an executable script defining the plurality of features for the application and a plurality of scenarios, each scenario representing a test for one or more features of the plurality of features of the application, and each feature comprising one or more user stories.

19. The system of claim 17, wherein the LM selects the first set of the plurality of context providers based on context associated with each of the one or more selected entities and entity types associated with each of the one or more selected entities, the first set of the plurality of context providers being a subset of the plurality of context providers, wherein each of the plurality of context providers comprises respective logic to select, from among a plurality of potential contexts, relevant context for a corresponding entity and entity type, and wherein, in the unified context graph, each of the plurality of context providers has a corresponding description regarding the respective logic.

20. The system of claim 17, wherein each of the plurality of context providers comprises respective logic to select, from among a plurality of potential contexts, relevant context for a corresponding entity and entity type, wherein, in the unified context graph, each of the plurality of context providers has a corresponding description regarding the respective logic, and wherein the embedding model determines the second set of relevant context providers using cosine similarity of the value vector embedding to a context provider vector embedding describing the corresponding description of the corresponding context provider.
